(19) United States
(12) Patent Application Publication
(10) Pub. No.: US 2012/0104835 A1
(43) Pub. Date: May 3, 2012

(54) Gauge Wheel for an Agricultural Machine

(76) Inventor: Keith Waldner, Dugald (CA)

(21) Appl. No.: 13/032,929

(22) Filed: Feb. 23, 2011

(30) Foreign Application Priority Data
Nov. 2, 2010 (CA) 2719667

(51) Int. Cl. A01B 63/16; B23P 17/00; B60B 3/16; B60B 3/10; B60B 3/04

(52) U.S. Cl. 301/64.101; 29/894.3

(57) ABSTRACT

A gauge wheel is formed from a peripheral rubber tire, a rim portion defined by first and second metal portions with flanges defining an inner edge spaced inwardly of the rim section and outwardly of the axis, a hub portion defined by third and fourth metal portions each shaped to define a bearing carrying inner section and a mounting flange with the mounting flanges bolted together the inner sections define a bearing support for receiving a bearing together with a metal plate member lying in a radial plane and having an outer ring portion bolted to one side of the mounting flanges of the rim portions, an inner ring portion bolted to one side of the mounting flanges of the hub portions and a plurality of spokes connecting the outer ring portion to the inner ring portion leaving mud discharge holes between the spokes.

This invention relates to a gauge wheel for an agricultural machine and to a method of manufacturing the gauge wheel.

### BACKGROUND OF THE INVENTION

In U.S. Pat. No. 7,584,706 (Smith) issued Sep. 8, 2009 discloses gauge wheel assembly for a farming implement is disclosed which comprises a hub portion positioned substantially centrally with respect to the assembly, a rim portion forming a circumference of the assembly and forming a circumferential ground contacting surface; and an intermediate portion positioned between and connecting the hub portion and the rim portion. The intermediate portion comprises a hub side section positioned about the hub portion, a rim side section positioned inwardly of the rim portion, and a plurality of spoke sections extending from the hub side section to the rim side section and connecting the hub side section to the rim side section. The rim side section encircling the plurality of spoke sections. The hub side section of the intermediate portion defines an aperture with the hub portion being positioned in the hub side section. The intermediate portion is separable from the rim portion and the hub portion.

The above patent discloses details of the use and mounting of the gauge wheel of the present invention so that reference may be made to this document for this further detail if required.

### SUMMARY OF THE INVENTION

It is one object of the invention to provide an improved gauge wheel.

According to one aspect of the invention there is provided a gauge wheel comprising:

a peripheral rubber tire defining a cylindrical member surrounding an axis of the wheel;

a rim portion defined by a first and a second metal portion each shaped to define a tire carrying rim section and a mounting flange lying in a radial plane of the axis and extending inwardly from the rim section so that with the flanges bolted together the rim sections define a peripheral channel for receiving the tire;

the flanges defining an inner edge spaced inwardly of the rim section and outwardly of the axis;

a hub portion defined by a third and a fourth metal portion each shaped to define a bearing carrying inner section and a mounting flange lying in a radial plane of the axis and extending outwardly from the inner section so that with the mounting flanges bolted together the inner sections define a bearing support for receiving a bearing;

and a metal plate member lying in a radial plane and having an outer ring portion bolted to one side of the mounting flanges of the rim portions, an inner ring portion bolted to one side of the mounting flanges of the hub portions and a plurality of spokes connecting the outer ring portion to the inner ring portion.

### BRIEF DESCRIPTION OF THE DRAWINGS

One embodiment of the invention will now be described in conjunction with the accompanying drawings in which:

FIG. 1 is a side elevational view of an assembled gauge wheel according to the present invention.

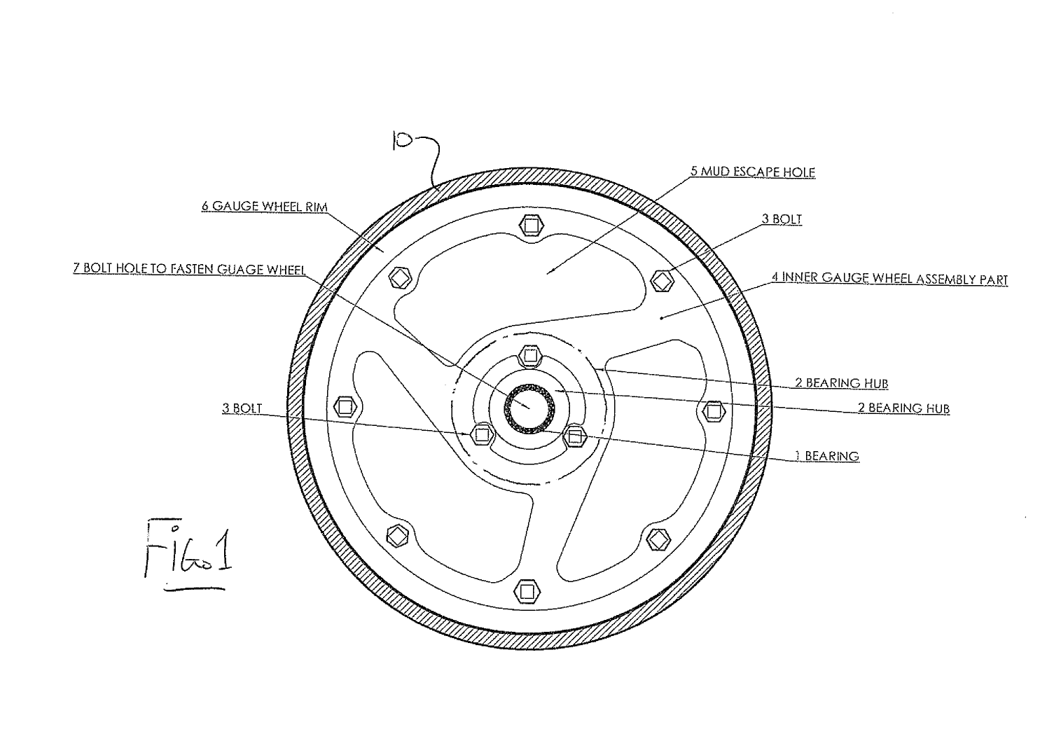

FIG. 2 is a side elevational view of an inner mounting plate of the assembled gauge wheel.

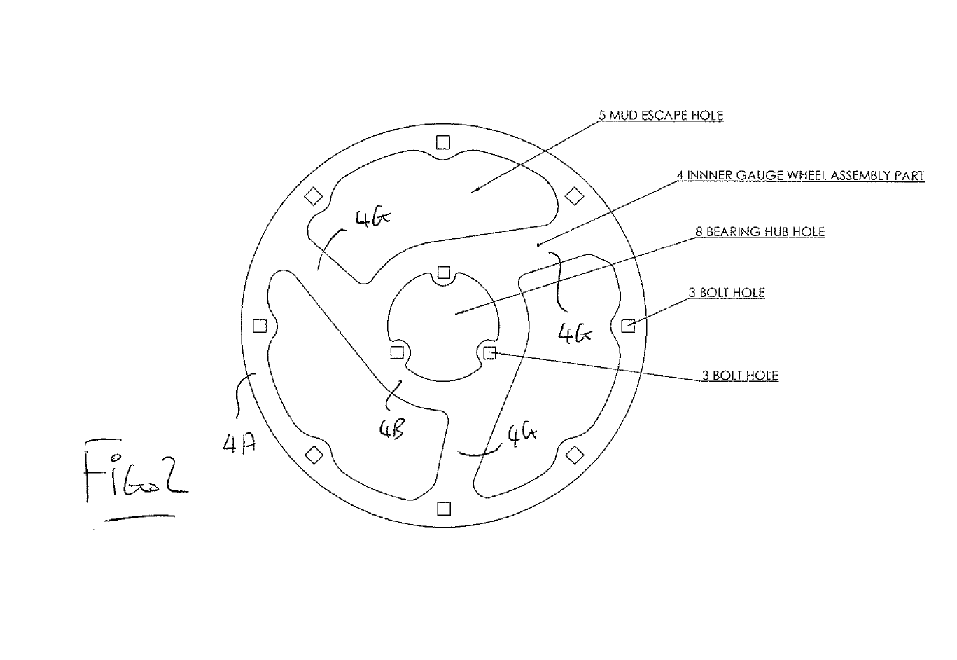

FIG. 3 is a side elevational view of a rim of the assembled gauge wheel.

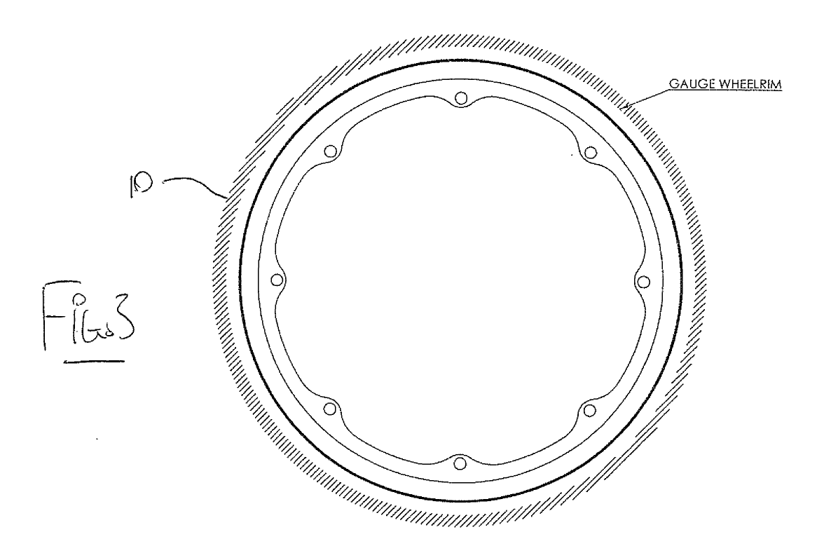

FIG. 4 is a cross-sectional view of the assembled gauge wheel.

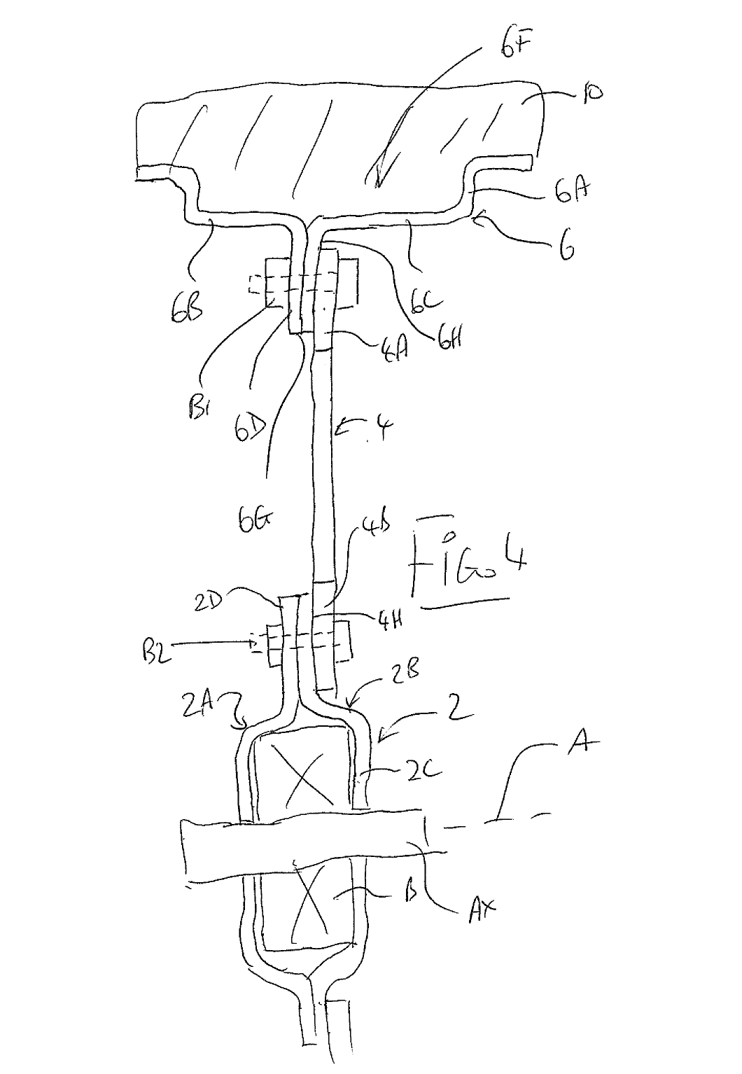

In the drawings like characters of reference indicate corresponding parts in the different figures.

### DETAILED DESCRIPTION

A gauge wheel is formed by

a) a peripheral rubber tire or rime 10 defining a cylindrical member surrounding an axis A of the wheel.

b) a rim portion 6 defined by a first and a second metal portion 6A and 6B each shaped to define a tire carrying rim section 6C and a mounting flange 6D lying in a radial plane of the axis and extending inwardly from the rim section 6A so that with the flanges 6D bolted together the rim sections 6A define a peripheral channel 6F for receiving the tire 10. The flanges define an inner edge 6G spaced inwardly of the rim section 6A and outwardly of the axis A.

c) a hub portion 2 defined by a third and a fourth metal portion 2A and 2B each shaped to define a bearing carrying inner section 2C and a mounting flange 2D lying in a radial plane of the axis A and extending outwardly from the inner section 2C so that with the mounting flanges 2D bolted together the inner sections 2C define a bearing support for receiving a bearing B of an axle AX.

d) a metal plate member 4 lying in a radial plane and having an outer ring portion 4A bolted by bolts B1 to one side 6H of the mounting flanges 6D of the rim portions, an inner ring portion 4B bolted by bolts B2 to one side 4H of the mounting flanges of the hub portions 2A, 2B and a plurality of spokes 4G connecting the outer ring portion to the inner ring portion. The spokes leave mud escape holes 5. Three holes 5 are shown but this can vary.

In the method of manufacture, existing wheels are obtained from a farmer which include the tire, the first single member with a common radial plate and a separate plastic plate portion mounting the bearing. Using the existing wheel, the first and third metal portions are cut from the first single member provided by the wheel to form an annular space between the mounting flanges. Thus the tire, bearing and first member are used and the plastic plate portion is discarded. A further single member is then obtained from a suitable source and is cut to form the annular piece which is removed to form the annular space between the second and fourth metal portions. The pieces are then assembled with the plate member 4 on one side to form the replacement gauge wheel.

The manufacture is provided as a service for refurbishing existing gauge wheels where the tire, bearing and the first single member are supplied by the existing gauge wheel and the second single member is provided as a separate member. This allows an inexpensive system to replace the existing gauge wheel which has issues of mud collection due to the solid center plate and replace it at low cost with the refurbished gauge wheel having the mud shedding openings between the spokes of the plate.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A gauge wheel comprising:
a peripheral rubber tire defining a cylindrical member surrounding an axis of the wheel;
a rim portion defined by a first and a second metal portion each shaped to define a tire carrying rim section and a mounting flange lying in a radial plane of the axis and extending inwardly from the rim section so that with the flanges bolted together the rim sections define a peripheral channel for receiving the tire;
the flanges defining an inner edge spaced inwardly of the rim section and outwardly of the axis;
a hub portion defined by a third and a fourth metal portion each shaped to define a bearing carrying inner section and a mounting flange lying in a radial plane of the axis and extending outwardly from the inner section so that with the mounting flanges bolted together the inner sections define a bearing support for receiving a bearing;
and a metal plate member lying in a radial plane and having an outer ring portion bolted to one side of the mounting flanges of the rim portions, an inner ring portion bolted to one side of the mounting flanges of the hub portions and a plurality of spokes connecting the outer ring portion to the inner ring portion.

2. A method of manufacturing the gauge wheel of claim 1 wherein the first and third metal portions are cut from a first single member with a common radial plate to form an annular space between the mounting flanges and the second and fourth metal portions are cut from a second single member with a common radial plate to form an annular space between the mounting flanges.

3. The method of claim 2 wherein the manufacture is provided as a service for refurbishing existing gauge wheels where the tire, bearing and the first single member are supplied by the existing gauge wheel and the second single member is provided as a separate member.
